(19) United States
(12) Patent Application Publication
(10) Pub. No.: US 2011/0175544 A1
(43) Pub. Date: Jul. 21, 2011

(54) Multifunctional Illuminating Lamp

(76) Inventor: Jung-Chang Jong, Taoyuan (TW)

(21) Appl. No.: 12/687,877

(22) Filed: Jan. 15, 2010

(51) Int. Cl. H05B 37/02

(52) U.S. Cl. 315/294

(57) ABSTRACT

A multifunction illumination lamp is provided. The multifunction illuminating lamp includes a body, an illuminating device, and a charging device. The illuminating device includes a plurality of LED units. Each LED unit includes red (R), green (G), and blue (B) color light emitting diodes (LED). The circuit controller controls currents flowing through the R, G, B LEDs, so as to control luminances of the R, G, B LEDs, and the controlled luminances of the R, G, B LEDs are adapted for mixing to achieve different color gamut. The charging device includes a transmitter and a receiver. When connected with a power supply, the transmitter generates an energy beam. The receiver is independent from the body and being adapted for constructing a circuit loop with an external electronic apparatus. The receiver transforms the received energy beam into electric energy and charges the electric energy into the electronic apparatus.

### BACKGROUND OF THE INVENTION

1. Field of the Invention

The present invention relates generally to an illuminating lamp, and more particularly, to an illuminating desk lamp.

2. The Prior Arts

A typical desk lamp usually employs a fluorescent lamp or an incandescent lamp serving as a light source for providing illumination. However, as conventionally known, a fluorescent lamp usually flickers, and after using such a flickering fluorescent lamp for a relatively long time, user's eyes often get tired. As to the incandescent lamp, it is also well known as a heat generator and therefore has low power efficiency.

Currently, light emitting diode (LED) technology has been well established, and LEDs have been adopted as light sources of many commercialized desk lamps. However, no matter fluorescent lamps, incandescent lamps, or LED lamps, they are featured to produce constant hues. When an ordinary person reads in a light of a conventional desk lamp, he may often suffer the discomfort of reading caused by the improper matching between the illumination provided by the desk lamp and the surface of the reading material. For example, a newspaper usually has a relatively rough surface and is featured with a paper textile, and such a newspaper surface often absorb more yellow light content under the illumination of a desk lamp. Therefore, the newspaper surface typically looked yellowish and less reflective in the light of the desk lamp. On the contrary, the surface of books printed with virgin pulp made papers typically absorbs more white light, so that the brightness of the surface of the book is enhanced, which may make the user uncomfortable. Particularly, some books for kids or hardcover books are printed with copperplate papers which are specifically more reflective, and thus such books are not only inconvenient for reading, but also likely to cause eyes fatigue.

### SUMMARY OF THE INVENTION

A primary objective of the present invention is to provide an illuminating lamp. The illuminating lamp is adapted for generating a light with a hue that is adjustable in accordance with practical surface characteristics of reading materials being read, so as to adaptively modify the hue and make it more acceptable to human's visual organs, and thus relieving fatigue of eyes.

A secondary objective of the present invention is to provide a desk lamp having a charging device, so as to provide the desk lamp a cordless charging function. In accordance with the desk lamp of the present invention, small daily used electronic apparatuses can be conveniently charged in an environment having no power supply cords in a tangle.

According to an embodiment of the present invention, an LED set constituted of a plurality of LED units of three primary colors, e.g., red (R), green (G), and blue (B) is provided serving as a light source. A circuit controller is employed for controlling luminances of the R, G, and B LED units. Different color gamut can be obtained by permutating and combining different luminances of R, G, and B LEDs. In such a way, the user is allowed to adjust the hue of the light source in accordance with the surface of the reading material, so as to achieve the most desired reading comfort.

According to another embodiment of the present invention, the present invention provides a desk lamp including a transmitter disposed on a body of the desk lamp, and an independent receiver adapted for constructing a circuit loop with an electronic apparatus. The transmitter is electrically connected to a circuit controller. When the transmitter is coupled with a power supply, it can generate an energy beam, and when the circuit loop is constructed by connecting the electronic apparatus with the receiver, the receiver receives the energy beam and correspondingly generates an electrical power by induction generation for charging the electronic apparatus.

The amount of the LED units determines the overall illumination of the desk lamp. As such, the amount should be decided by the manufacturer of the desk lamp in accordance with the general demand for ordinary reading requirement.

According to an aspect of the embodiment, the LED units are modularized into modules, and the modules are respectively assembled to the body of the desk lamp. Even though LED units typically have relatively long life spans, should any one of them damages, the damaged one could be individually replaced.

With respect to the foregoing transmitter and receiver for transmitting and receiving the energy beam respectively, the present invention prefers to transmit radio frequency (RF) energy in the 900 MHz band to a wireless sensor for induction generation. When the circuit loop is constructed by connecting the electronic apparatus with the receiver, the receiver can then charge the electronic apparatus. It is worth mentioning that the receiver and the transmitter must be maintained within a certain distance range for effective operation.

### BRIEF DESCRIPTION OF THE DRAWINGS

The present invention will be apparent to those skilled in the art by reading the following detailed description of preferred embodiments thereof, with reference to the attached drawings, in which:

FIG. 1 is a schematic diagram illustrating a desk lamp according to an embodiment of the present invention;

FIG. 2 is a schematic diagram illustrating the distribution of the illumination apparatuses on the body of the desk lamp according to an embodiment of the present invention; and

FIG. 3 illustrates a desk lamp including a charging device according to an embodiment of the present invention.

### DETAILED DESCRIPTION OF THE PREFERRED EMBODIMENT

The accompanying drawings are included to provide a further understanding of the invention, and are incorporated in and constitute a part of this specification. The drawing illustrates embodiments of the invention and, together with the description, serves to explain the principles of the invention.

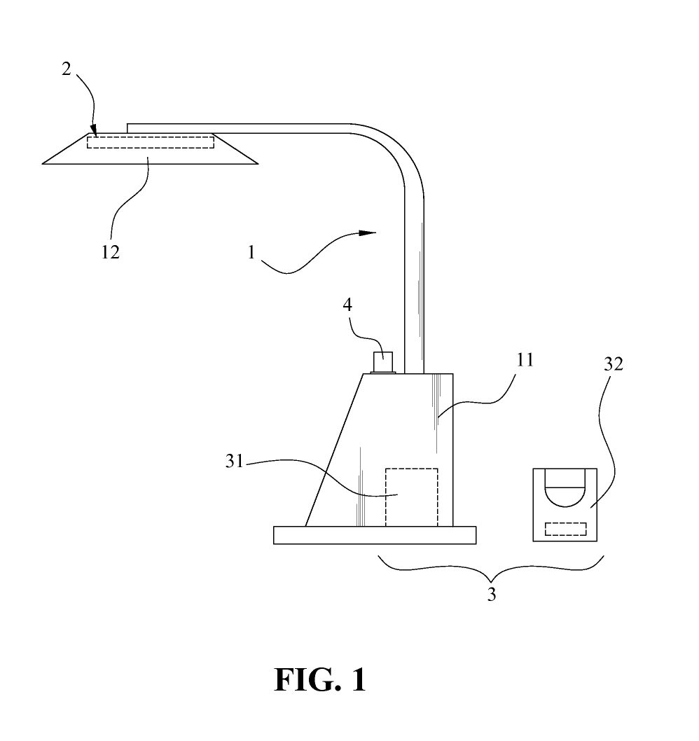

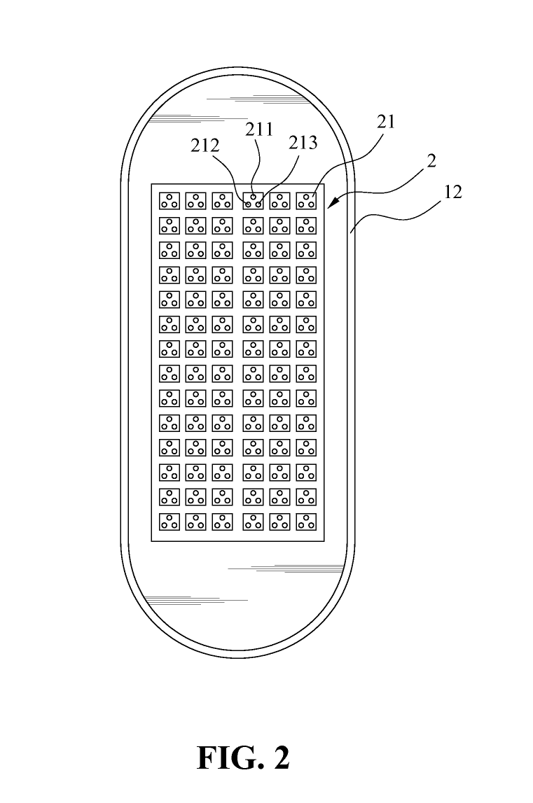

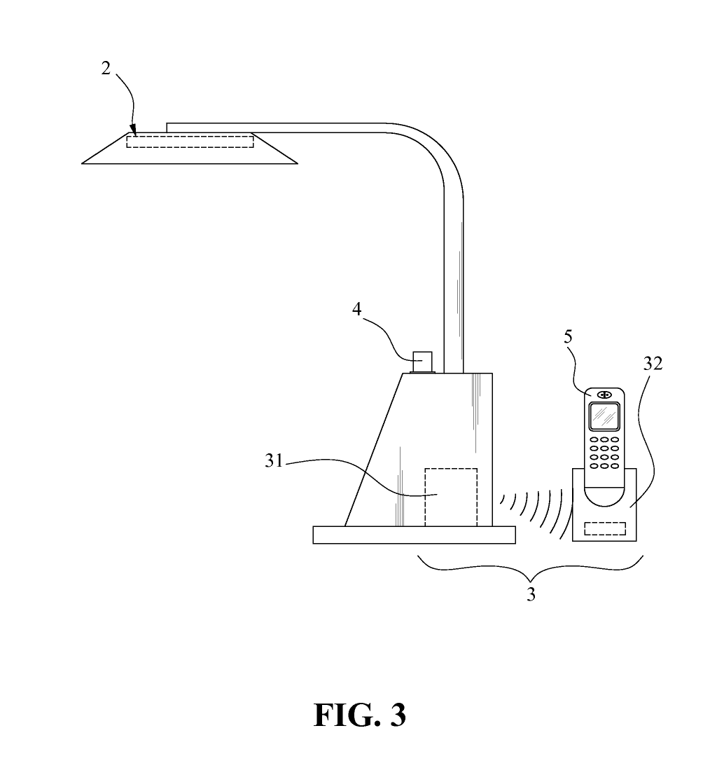

FIG. 1 is a schematic diagram illustrating a desk lamp according to an embodiment of the present invention. FIG. 2 is a schematic diagram illustrating the distribution of the illumination apparatuses on the body of the desk lamp according to an embodiment of the present invention. FIG. 3 illustrates a desk lamp including a charging device according to an embodiment of the present invention. Referring to FIGS. 1 through 3, there is shown a multifunctional illuminating lamp. The multifunctional illuminating lamp can be adapted to serve as a desk lamp. The multifunctional illuminating lamp includes a body 1, an illuminating device 2, a charging device 3, and a circuit controller 4. The body 1 is configured as an ordinary desk lamp, and includes a base 11, a lampshade 12. The base 11 is adapted for being stably positioned on a desk surface, and has a supporting rod upwardly extending therefrom. The lampshade 12 is disposed on an end of the supporting end. The illuminating device 2 is provided under the lampshade. The circuit controller 4 is disposed at a suitable position of the base 11.

As shown in FIG. 2, the illuminating device 2 includes a plurality of LED units 21. Each LED unit 21 further includes three primary color LEDs, i.e., red (R) LED 211, green (G) LED 212, and blue (B) LED 213. The LED units 21 are electrically connected to the circuit controller 4. Preferably, the circuit controller is designed in a manner of a tuning knob for convenience of operation. When the circuit controller 4 is being tuned, current values flowing through the R, G, B LEDs 211, 212, 213 are controlled, so that the luminances thereof are correspondingly controlled. In accordance with the permutation and combination of different luminances of the R, G, B LEDs, different color gamut can be obtained. In such a way, the user is allowed to adjust hue the desk lamp to achieve a comfortable light in accordance with the surface of the reading material, so as to achieve the most desired reading comfort.

The amount of the LED units 21 determines the overall illumination of the desk lamp. As such, the amount can be decided by the manufacturer of the desk lamp in accordance with the general demand for ordinary reading requirement.

According to an aspect of the embodiment, the LED units 21 are modularized into modules, and the modules are respectively assembled to the body 1 of the desk lamp. Even though LED units 21 typically have relatively long life spans, should any one of them damages, the damaged one could be individually replaced.

The charging device 3 includes at least one transmitter 31 and at least one receiver 32. The transmitter 31 is assembled at the body 1 and electrically connected to the circuit controller 4. The receiver 32 is independent from the body 1 and is adapted for constructing a circuit loop with a circuit unit of an external electronic apparatus 5. The circuit controller 4 can be used to control whether or not to supply power to the transmitter 31. When the transmitter 31 is connected with a power supply, it generates an energy beam. When being positioned within a specific distance, the receiver 32 can receive the energy beam. If the electronic apparatus 5 is in conjunction with the receiver 32, such that the circuit unit of the electronic apparatus 5 constructs the circuit loop with the receiver 32, the receiver 32 generates an electrical energy in accordance with an induction generation process with the received energy beam, and charges the generated electrical energy to the electronic apparatus 5.

The present invention prefers to transmit radio frequency (RF) energy in the 900 MHz band to a wireless sensor inside the receiver 32 for induction generation. When the circuit loop is constructed by connecting the electronic apparatus 5 with the receiver 32, the receiver 32 can then charge the electronic apparatus 5.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A multifunction illuminating lamp, comprising:
a body, comprising a circuit controller;
an illuminating device, comprising a plurality of LED units, each LED unit comprising red (R), green (G), and blue (B) color light emitting diodes (LED), wherein the LED unit is electrically connected to the circuit controller, and the circuit controller is adapted for controlling currents flowing through the R, G, B LEDs, so as to control luminances of the R, G, B LEDs, and the controlled luminances of the R, G, B LEDs are adapted for mixing to achieve different color gamut; and
a charging device, comprising:
at least one transmitter, disposed on the body and electrically connected to the circuit controller, wherein when the transmitter is connected with a power supply, the transmitter generates an energy beam; and
at least one receiver, configured independent from the body and being adapted for constructing a circuit loop with a circuit unit of an external electronic apparatus, wherein the receiver is adapted to receive the energy beam and transform the received energy beam into electric energy by an induction generation process and charge the electric energy into the electronic apparatus.
